(19) United States
(12) Patent Application Publication
(10) Pub. No.: US 2020/0278262 A1
(43) Pub. Date: Sep. 3, 2020

(54) SENSOR LINE

(71) Applicant: LEONI KABEL GMBH, Roth (DE)

(72) Inventors: Bernd Janssen, Friesoythe (DE); Heiko Weber, Nortmoor (DE)

(21) Appl. No.: 16/635,642

(22) PCT Filed: Jul. 23, 2018
(86) PCT No.: PCT/EP2018/069930

§ 371 Date: Jan. 31, 2020

(30) Foreign Application Priority Data
Aug. 2, 2017 (DE) 10 2017 213 382.1
Jun. 1, 2018 (EP) 18 175 517.4

(51) Int. Cl. G01K 7/34

(52) U.S. Cl. CPC G01K 7/343

(57) ABSTRACT

A sensor line for detecting an external influence on a cable is described. The sensor line comprises: a first electrically conductive wire, which is enclosed in at least a first sub-region by a first dielectric, and a second electrically conductive wire, which is enclosed in at least a second sub-region by a second dielectric. The sensor line is configured so that a property of the first dielectric is variable under the external influence in at least one region of the sensor line. The external influence is detectable due to a change in a property of the first electrically conductive wire caused by the change in the property of the first dielectric in the at least one region of the sensor line.

The invention relates to a sensor line, a shielded pair or a star quad and a system or a method for detecting an external influence on a cable as well as a method for determining a temperature or a temperature change.

Sensor lines can be constructed coaxially according to the prior art, wherein these sensor lines are based on the fact that signals are passed to the line and different information can be determined from the measuring results, such as e.g. reflections.

Measurements that are recorded using such coaxially constructed lines as sensor can be evaluated, for example, by means of time-domain reflectometry (TDR) and frequency-domain reflectometry (FDR, by means of vector network analysers (VNA)).

One problem with coaxial construction, however, is that these lines are more susceptible to electromagnetic influences than symmetrically constructed lines. This is due among other things to the fact that the shield acts as a return conductor, but at the same time forms a type of antenna for external interference signals. Coaxial lines themselves also generate stronger disturbance variables for their environment.

As far as is known, no effects such as mode conversion or skew, for example, have been utilised up to now in sensor lines to obtain information from these effects. With a coaxial line only one parameter is still used for analysis (S11 or T11).

In the coaxial sensor element the returning signal (reflection, which is required for the analysis) is overlaid with the transmitted signal, so that a directional coupler, for example, may possibly be required.

With regard to the above, cables or sensor lines for cables need further improvements to be able to detect external influences on the cables more accurately or at all.

According to some configurations, the invention is based in particular on a sensor line, which comprises a wire pair, wherein the two wires of the wire pair are enclosed by dielectrics with respectively different properties in at least one region of the sensor line.

To this end the invention teaches a sensor line for detecting an external influence on a cable, wherein the sensor line comprises: a first electrically conductive wire, which is enclosed in at least a first sub-region by a first dielectric, and a second electrically conductive wire, which is enclosed in at least a second sub-region by a second dielectric, wherein the sensor line is configured so that a property of the first dielectric is variable under the external influence in at least one region of the sensor line, and wherein the external influence is detectable due to a change in a property of the first electrically conductive wire caused by the change in the property of the first dielectric in the at least one region of the sensor line.

Due to the change in the property of the first electrically conductive wire, mode conversion and/or skew can arise, for example, by means of which the external influence on the cable can be determined.

The measuring principle can be applied in this case in the time domain (skew measurement) and in the frequency domain (VNA measurement) and, as applied in some configurations, in a simple manner at a fixed frequency (for example, using a sinus generator with amplitude measuring unit, wherein the frequency possibly has to be adapted to the line length and the measurement range—see below).

In the case of asymmetry, skew and/or mode conversion thus arises, which can be detected. The external influence on the cable can thus be detected and analysed, as the external influence directly causes a change in the property of the first dielectric in the at least one region of the sensor line, due to which the property of the first electrically conductive wire can change.

Let it be noted here that according to some configurations, the first or the second dielectric can enclose the first or second electrically conductive wire completely, meaning over an entire length of the sensor line.

In one configuration of the sensor line, a property of the second dielectric is variable under the external influence in the at least one region of the sensor line, wherein a property of the second electrically conductive wire is variable due to the change in the property of the second dielectric, wherein the changes in the properties of the first and second electrically conductive wires differ, and wherein the external influence is detectable by means of the different changes in the properties of the first and second electrically conductive wires.

The changes in the properties of the first and second electrically conductive wires can differ in this case in their magnitude and/or in their nature, for example.

The different changes in the properties of the first and second electrically conductive wires can be attributed in this case, according to some configurations, to the different properties of the first and second dielectrics in the at least one region of the sensor line.

Due to the different effects on the properties of the first and second electrically conductive wires, it is thus possible to detect the external influence on the cable, since skew and/or mode conversion, for example, can form as described above.

In another configuration of the sensor line, the first electrically conductive wire has a first signal velocity, v₁, in the at least one region of the sensor line, wherein the second electrically conductive wire has a second signal velocity, v₂, in the at least one region of the sensor line, wherein the sensor line is configured so that, on account of the change in the property of the first dielectric, v₁ changes by an amount Δv₁, and wherein the external influence can be determined and/or detected by means of the change of v₁ by Δv₁.

In the case of an effect of the change in the property of the first dielectric on the signal velocity, v₁, of the first electrically conductive wire, the external influence on the cable can be detected by means of a simple construction.

Let it be noted here that without an external influence on the cable, v₁ can be equal to v₂, but does not have to be identical in the context of some configurations of the invention.

In another configuration of the sensor line, due to the change in the property of the second dielectric, a change in v₂ by an amount Δv₂ can be produced, wherein Δv₁≠Δv₂, and wherein the external influence is detectable by a change in the difference v₁−v₂ by Δv₁−Δv₂.

The change in the difference v₁−v₂ by Δv₁−Δv₂ can be measured particularly easily in this case by a suitable measuring apparatus.

In another configuration of the sensor line, the electrically conductive wires in the at least one region of the sensor line each have a certain signal velocity, wherein the sensor line is configured so that, due to the change in the property of at least one dielectric, the respective change due to external influence is detectable. In one configuration the change detectable due to an external influence in the two lines is not identical.

In another configuration of the sensor line, the property of the first dielectric comprises the permeability of the first dielectric. In some configurations the permeability changes as a function of the temperature, so that the temperature and/or the temperature change can be determined, for example, by way of the skew and/or mode conversion arising. These configurations can also be applied in sensor lines in which the property of the second dielectric is variable under the external influence in the at least one region of the sensor line.

In one configuration of the sensor line, the external influence comprises one or more of temperature, temperature change, pressure, pressure change, medium intrusion and mechanical load. These can be measured or detected in some configurations in particular by means of the changes in v₁ and/or v₂.

In another configuration of the sensor line, the first electrically conductive wire has a first compressibility, k₁, in the at least one region of the sensor line, wherein the second electrically conductive wire has a second compressibility, k₂, in the at least one region of the sensor line, and wherein k₁≠k₂. In one example the electrically conductive wire with higher compressibility compresses more strongly under mechanical load than the other electrically conductive wire, due to which mode conversion can arise.

In another configuration, the sensor line is configured so that due to the external influence, the first electrically conductive wire in the at least one region is compressed by a factor d₁, with d₁>0 or d₁<0, and the second electrically conductive wire in the at least one region is compressed by a factor d₂, with d₂>0 or d₂<0 or d₂=0, wherein d₁≠d₂, and wherein the sensor line is further configured so that mode conversion and/or skew can be caused in the sensor line due to the condition d₂.

It is possible that in some configurations, the second electrically conductive wire cannot be compressed under certain conditions, wherein under these conditions the first electrically conductive wire is compressed. The skew and/or mode conversion thus arising can be detected and analysed in a simple manner.

The external influence or a change in the external influence can cause the first electrically conductive wire and/or the second electrically conductive wire to be compressed or elongated. The direction of the compression or elongation is oriented in this case to the direction of the external influence which acts on the cable or the sensor line.

In another embodiment of the sensor line, this is configured so that the external influence can be detected and/or analysed (i) by means of the S-parameters Sdd11, Scd11 and Scc11, and/or (ii) by means of the T-parameters Tdd11, Tcd11 and Tcc11.

With this configuration of the sensor line, three parameters can now be used for the analysis: (i) Sdd11, Scd11 and Scc11; or (ii) Tdd11, Tcd11 and Tcc11. Let it be mentioned that a return signal (reflection, which is required for analysis) only arises in is the case of the parameters Scd11/Tcd11, Sdc11/Tdc11 if asymmetry is present. This means that no measuring signal is present as long as the line is symmetrical. As soon as the asymmetry rises, a measuring signal arises as a function of the disturbance, wherein in this case transmitted and received signal components do not have to be decoupled.

The invention further teaches a star quad, which comprises a sensor line according to one of the configurations described here, wherein the star quad is configured in such a way as to detect the external influence by means of crosstalk information. Even more precise detection or analysis of the external influence on the cable can thus take place due to the additional crosstalk information and/or crosstalk behaviour.

The invention further teaches a system comprising: the sensor line or the star quad according to one of the configurations described here, and a measuring unit, which is coupled to the sensor line and is configured to detect and/or analyse the external influence.

The invention further teaches a method for the detection of an external influence on a cable, wherein the method comprises: provision of a sensor line, wherein the sensor line comprises: a first electrically conductive wire, which is enclosed in at least a first sub-region by a first dielectric, and a second electrically conductive wire, which is enclosed in at least a second sub-region by a second dielectric; and detection of a change in a property of the first dielectric in at least one region of the sensor line by means of detection of a change in a property of the first electrically conductive wire and/or detection of a change in a property of the second dielectric in the at least one region of the sensor line by means of detection of a change in a property of the second electrically conductive wire, in order to detect the external influence on the first and/or second dielectric and thereby the cable.

In one configuration of the method, the first electrically conductive wire has a first signal velocity, v₁, in the at least one region, wherein the second electrically conductive wire has a second signal velocity, v₂, in the at least one region, and wherein the detection of the change in the property of the first and/or second electrically conductive wire comprises: detection of a change in v₁ by an amount Δv₁ and/or a change in v₂ by an amount Δv₂; and determination of a change in v_{d}=v₁−v₂ by an amount Δv_{d}=Δv₁−Δv₂. This configuration permits a particularly simple and low-cost method for detecting the external influence on the cable.

The invention further teaches a method for determining a temperature or a temperature change, which acts on a cable (or the sensor line), wherein the method comprises a method of one of the configurations illustrated above for detecting an external influence on a cable, wherein the property of the first or second dielectric comprises the permeability of the first or second dielectric, wherein the permeability is a function of the temperature, and wherein the method for determining the temperature or the temperature change comprises: analysing the amount Δv_{d}, which is produced by a change in the temperature-dependent permeability of the first or second dielectric, in order to determine the temperature or temperature change.

The invention further teaches a sensor line for detecting an external influence on a cable, wherein the sensor line comprises: a first electrically conductive wire, and a second electrically conductive wire, wherein the sensor line is configured so that a property of the first electrically conductive wire can be influenced differently by the external influence compared with the second electrically conductive wire. This permits the detection and/or determination of the external influence, even though the two wires do not necessarily have different properties without the external influence. This can be guaranteed by a pressure sensor, for example, in which the possible pressure can deform only one wire. The aforesaid preferred configurations can be applied to this sensor line in an equivalent manner.

Let it be noted here that all preferred configurations of the sensor line or of the star quad can be applied in an equivalent manner to the methods for detecting an external influence on a cable and for determining a temperature or a temperature change.

Let it further be noted that any configurations can be combined with one another or realised independently of one another in a sensible manner.

Exemplary embodiments of the invention are described in greater detail below with reference to the drawings.

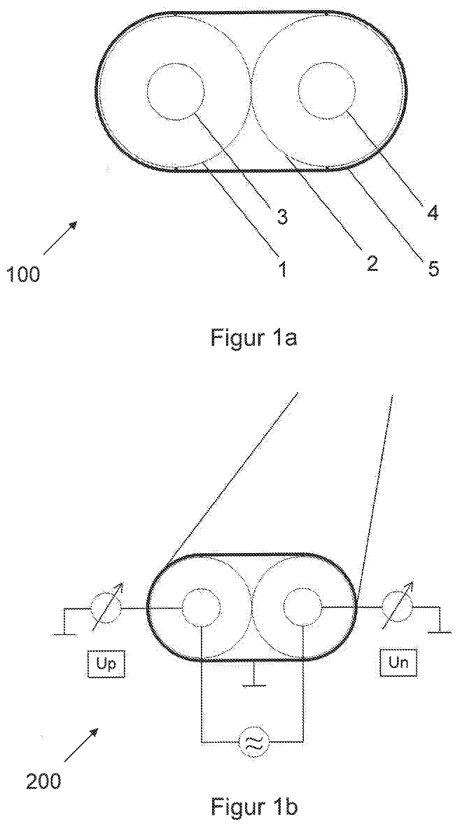

FIGS. 1a and b show schematically a sensor line and a system according to configurations of the invention described here.

As mentioned above, a problem with coaxial construction is that these lines are more susceptible to electromagnetic influences compared with symmetrically constructed lines. This may be due to the fact that the shield acts as a return conductor, but also forms an antenna. Furthermore, coaxial lines can themselves generate stronger disturbance variables for their environment. With a coaxial line only one parameter is still used for analysis (S11 or T11). Since the return signal is overlaid by the transmitted signal in a coaxial sensor element, a directional coupler may be necessary.

The aim is usually to construct both wires of a pair as identically (meaning symmetrically) as possible in respect of the dimensions and the dielectric constant, in order not to change the signal modes (mode conversion) during the transmission. In the case of different dielectric constants, the two components of the signal transmitted propagate at different signal velocities and thus a so-called skew arises in the time domain or mode conversion in the frequency domain. This applies both from odd (differential mode) to even (common mode) mode and vice versa and applies to transmitted signals and to reflected signals. In some configurations of the present invention this effect is used so that both wires have similar dimensions and, for example at room temperatures, also have a similar dielectric constant. In some examples, however, the two wires are insulated using different materials, wherein—in the case of a temperature measurement—at least one material changes permeability (“dielectric variable”) as a function of the temperature. The temperature can be determined by means of some configurations with reference to the skew or mode conversion thus arising. To this end it may perhaps be necessary to use a reference point, with reference to which a possible calibration is enabled in order to be able to determine the absolute temperature.

The measuring principle can be used in the time domain (skew measurement) and in the frequency domain (VNA measurement), and in a simpler manner at a fixed frequency (for example, sinus generator with amplitude measuring unit, wherein, in some configurations, the frequency must be adapted to line length and measuring range).

Some configurations are configured in such a way that one of the two wires is formed so that, in the event of a medium intrusion and/or under mechanical load, it deliberately behaves differently from the other wire. For example, a wire that is relatively compressible (in relation to the other wire), meaning a soft wire, and a relatively incompressible wire, meaning a hard wire, can be used. Under mechanical load the soft wire can compress more than the hard wire, so that mode conversion can arise.

The two wires of the sensor line act as a type of comparator.

If it is not necessarily required that the location and magnitude of the disturbance have to be determined precisely, it can be sufficient to introduce a (e.g. sinusoidal) signal between the two wires at a fixed frequency and to measure the reflected or transmitted signal between the two wires and shield. The reverse case can equally be realised. With a high symmetry the measuring signal is 0, with asymmetry (influence due to temperature changes, mechanical load etc., for example), on the other hand, it is not. The extent of the mode conversion is dependent on length/magnitude of the asymmetry and on the frequency.

Configurations of the present invention thus utilise effects such as mode conversion and/or skew to obtain information from these with regard to external influences on the cable.

FIG. 1a shows schematically a sensor line 100 according to a configuration of the invention described here.

In this example the sensor line 100 comprises a first dielectric 1, a first electrically conductive wire 3, a second dielectric 2 and a second electrically conductive wire 4.

The sensor line further comprises a shield 5 in this example.

FIG. 1b shows schematically a measuring construction 200 for detecting an external influence on a cable.

During the aforesaid odd mode, a signal is applied between the first electrically conductive wire 3 and the second electrically conductive wire 4. During the even mode, a signal is applied between the electrically conductive wires 3+4 and the shield 5.

In this example the dielectric 1 has different properties under the influence of mechanical and/or thermal factors compared with the dielectric 2.

As described above, other S- or T-parameters can now also be included for evaluation compared with the coaxial line, The above example uses mode conversion for a sensor system. Furthermore, a star quad (comprising 4 wires) is used as sensor in some configurations, wherein crosstalk can then also be used as information, for example.

With the symmetrical line the problem of electromagnetic compatibility is circumvented depending on the parameters measured. In the case of the parameter Sdd11 or Tdd11, the influence is normally extremely slight, as the shield constitutes neither forward nor return conductor. However, in the case of the parameters Scc11 or Tcc11, the influence is equal to that of the coaxial element.

In symmetrical lines according to the prior art, the wires are not intentionally or consciously conceived with different properties, so that various influences and states can be detected. With the symmetrical line according to configurations of the invention described here, 3 parameters can now be used for analysis: Sdd11, Scd11 and Scc11 or Tdd11, Tcd11 and Tcc11.

A return signal (reflection, which is required for analysis) only arises in the case of the parameters Scd11/Tcd11, Sdc11/Tcd11 if asymmetry is present, wherein the return signal is a function of the asymmetry. This means that a measuring signal is scarcely present as long as the line is symmetrical. As soon as the asymmetry (for example, as a function of the temperature or the pressure) increases, a measuring signal arises as a function of the disturbance. In this case transmitted and received signal components do not have to be decoupled.

Advantages of the configurations of the present invention include a simple construction, a relatively low-cost construction and, associated with this, relatively low-cost methods for detecting an external influence on a cable, several possible, known measuring principles that can be applied, EMC (electromagnetic immunity/compatibility) and EMI (electromagnetic interference) insensitivity, the possibility of using low measuring frequencies, compatibility with many measuring systems and universal applicability.

In the case of several wire pairs in the symmetrical line, it can be distinguished whether only pressure is being exerted on one of the two wires, for example. Information can be deduced via this with regard to the direction (in the cross section) of the pressure exerted on the wires. The direction in which a line is bent can also be determined in some configurations.

Symmetrical lines usually have a lower insertion loss, so that greater application lengths or smaller diameters for the same application length are possible.

The line capacity is usually smaller in symmetrical lines. Due to this, the rise time of the transmitted signal in TDR measurements, which time can be significant for the quality of the measurement, is less strongly influenced, whereupon the local resolution is improved.

Symmetrical lines according to embodiments of the invention described here deliver more information compared with coaxial lines, enable a simpler construction (no directional coupler, fixed frequency, etc.) depending on the type of connection and measuring task, are substantially more sensitive and offer better EMC performance.

Finally, let it be pointed out in particular that the exemplary embodiments discussed above serve only to describe the claimed doctrine, but do not limit this to the exemplary embodiments. For example, it should be mentioned here that the sensor line can be used in other cases as an intelligent sensor line.

1-21. (canceled)

22. A sensor line for detecting an external influence on a cable, wherein the sensor line comprises:
a first electrically conductive wire, which is enclosed by a first dielectric in at least a first sub-region, and
a second electrically conductive wire, which is enclosed by a second dielectric in at least a second sub-region,
wherein the sensor line is configured so that a property of the first dielectric is variable under the external influence in at least one region of the sensor line, and
wherein the external influence is detectable due to a change in a property of the first electrically conductive wire caused by the change in the property of the first dielectric in the at least one region of the sensor line,
wherein the first electrically conductive wire in the at least one region of the sensor line has a first compressibility, k₁,
wherein the second electrically conductive wire in the at least one region of the sensor line has a second compressibility, k₂, and
wherein k₁≠k₂.

23. The sensor line according to claim 22, wherein the external influence comprises mechanical load on the cable, and wherein the first electrically conductive wire is adapted to compress more strongly under mechanical load than the second electrically conductive wire, due to which mode conversion can be caused, by means of which the external influence is detectable.

24. The sensor line according to claim 22, wherein a property of the second dielectric is variable under the external influence in the at least one region of the sensor line, wherein a property of the second electrically conductive wire is variable caused by the change in the property of the second dielectric,
wherein the changes in the properties of the first and second electrically conductive wires differ, and
wherein the external influence is detectable by means of the different changes in the properties of the first and second electrically conductive wires.

25. The sensor line according to claim 22, wherein the first electrically conductive wire in the at least one region of the sensor line has a first signal velocity, v₁,
wherein the second electrically conductive wire in the at least one region of the sensor line has a second signal velocity, v₂,
wherein the sensor line is configured so that, due to the change in the property of the first dielectric, v₁ changes by an amount Δv₁′, and
wherein the external influence is determinable and/or detectable by means of the change of v₁ by Δv₁.

26. The sensor line according to claim 25, wherein due to the change in the property of the second dielectric, a change in v₂ by an amount Δv₂ can be caused, wherein λv₁≠Δv₂, and wherein the external influence is detectable by means of a change in the difference v₁−v₂ by Δv₁′−Δv₂.

27. The sensor line according to claim 22, wherein the respective electrically conductive wire in the at least one region of the sensor line has a certain signal velocity, and wherein the sensor line is configured so that, due to the change in the property of at least one dielectric, the respective change due to external influence is detectable.

28. The sensor line according to claim 27, wherein the detectable change in the two lines due to an external influence is not identical.

29. The sensor line according to claim 22, wherein the property of the first dielectric comprises the permeability of the first dielectric.

30. The sensor line according to claim 29, wherein the permeability of the first dielectric is temperature-dependent.

31. The sensor line according to claim 24, wherein the property of the first or second dielectric comprises the permeability of the first or second dielectric.

32. The sensor line according to claim 31, wherein the permeability of the first dielectric and/or the permeability of the second dielectric are temperature-dependent.

33. The sensor line according to claim 22, wherein the external influence comprises one or more of temperature, temperature change, pressure, pressure change, medium intrusion and mechanical load.

34. The sensor line according to claim 22, wherein the sensor line is configured so that due to the external influence, the first electrically conductive wire is compressed in the at least one region by a factor d₁, with d₁>0 or d₁<0, and the second electrically conductive wire is compressed in the at least one region by a factor d₂, with d₂>0 or d₂<0 or d₂=0,
wherein d₁≠d₂, and
wherein the sensor line is further configured so that mode conversion and/or skew can be caused in the sensor line due to the condition d₁≠d₂.

35. The sensor line according to claim 22, wherein the first electrically conductive wire and the second electrically conductive wire have substantially identical dimensions and dielectric constants.

36. The sensor line according to claim 22, configured so that the external influence can be detected and/or analysed
(i) by means of the S-parameter Sdd11, Scd11 and Scc11, and/or
(ii) by means of the T-parameter Tdd11, Tcd11 and Tcc11.

37. A star quad comprising the sensor line according to claim 22, wherein the star quad is configured to detect the external influence by means of crosstalk information.

38. A system comprising:
the sensor line according to claim 22 or the star quad according to claim 37, and
a measuring unit, which is coupled to the sensor line and configured to detect and/or analyse the external influence.

39. A method, comprising:
provision of a sensor line, wherein the sensor line comprises:
a first electrically conductive wire, which is enclosed in at least a first subregion by a first dielectric, and
a second electrically conductive wire, which is enclosed in at least a second sub-region by a second dielectric; and
detection of a change in a property of the first dielectric in at least one region of the sensor line by means of detection of a change in a property of the first electrically conductive wire and/or detection of a change in a property of the second dielectric in the at least one region of the sensor line by means of detection of a change in a property of the second electrically conductive wire, in order to detect the external influence on the first and/or second dielectric and thereby the cable,
wherein the external influence comprises mechanical load on the cable,
wherein the first electrically conductive wire in the at least one region of the sensor line has a first compressibility, k₁,
wherein the second electrically conductive wire in the at least one region of the sensor line has a second compressibility, k₂, and
wherein k₁≠k₂.
wherein the first electrically conductive wire is adapted to compress more strongly under mechanical load than the second electrically conductive wire, due to which mode conversion arises, by means of which the external influence is detectable.

40. The method according to claim 39, wherein the first electrically conductive wire has a first signal velocity, v₁, in the at least one region,
wherein the second electrically conductive wire has a second signal velocity, v₂, in the at least one region, and
wherein the detection of the change in the property of the first and/or second electrically conductive wire comprises:
detection of a change in v₁ by an amount Δv₁ and/or a change in v₂ by an amount Δv₂; and
determination of a change in v_{d}=v₁−v₂ by an amount Δv_{d}=Δv₁−Δv₂.

41. The method according to claim 40, wherein the property of the first or second dielectric comprises the permeability of the first or the second dielectric, wherein the permeability is temperature-dependent, and wherein the method further comprises:
determining a temperature or a temperature change by analysing the amount Δv_{d}, which is produced by a change in the temperature-dependent permeability of the first or second dielectric, in order to determine the temperature or temperature change.

42. A sensor line for detecting an external influence on a cable, wherein the sensor line comprises:
a first electrically conductive wire, and
a second electrically conductive wire,
wherein the first electrically conductive wire in the at least one region of the sensor line has a first compressibility, k₁,
wherein the second electrically conductive wire in the at least one region of the sensor line has a second compressibility, k₂, and
wherein k₁≠k₂
wherein the external influence comprises mechanical load on the cable, and
wherein the first electrically conductive wire is adapted to compress more strongly under mechanical load than the second electrically conductive wire, due to which mode conversion can be caused, by means of which the external influence is detectable.
